(19) United States
(12) Patent Application Publication
(10) Pub. No.: US 2007/0079258 A1
(43) Pub. Date: Apr. 5, 2007

(54) APPARATUS AND METHODS OF DISPLAYING A ROUNDISH-SHAPED MENU

(75) Inventors: Kuan-Hong Hsieh, Shenzhen (CN); Han-Che Wang, Shenzhen (CN); Xiao-Guang Li, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,393

(22) Filed: Aug. 3, 2006

(30) Foreign Application Priority Data
Sep. 30, 2005 (CN) 200510100107.4

(51) Int. Cl. G06F 17/00

(52) U.S. Cl. 715/853

(57) ABSTRACT

A display apparatus and methods for displaying a roundish-shaped menu. In one embodiment, the display apparatus includes a screen and a frame connected to the screen. The screen has a first menu region and a second menu region. The menu in the second menu region is a sub-menu of a menu option of the menu in the first menu region. The frame has a first touch strip and a second touch strip. Each touch strip corresponds to one of the menu regions, and allows one to select a desired menu option to perform an associated function.

### TECHNICAL FIELD

The present invention relates to a display apparatus and display methods therefor, and particularly to a display apparatus and methods of displaying a roundish-shaped menu.

### GENERAL BACKGROUND

Generally, a display apparatus is a device to visually output information including texts and graphics on a screen. It is widely and increasingly used in electronic devices. A first conventional display apparatus includes a screen to display data (i.e., an image) thereon, and a frame to support the screen. The frame is further disposed a plurality of mechanical function buttons thereon to actuate any desired function. The more functions the display apparatus has, the more mechanical function buttons the frame is disposed thereon. Therefore, the frame should be designed as large as possible to hold the mechanical function buttons. As a result, a volume of the display apparatus as a whole becomes larger, and an overall appearance of the whole display apparatus looks untidy.

A second conventional display apparatus adopts a touch screen instead of mechanical buttons. The touch screen using graphical user interface (GUI) displays on the display screen thereof buttons, allowing a user to touch by finger or the like for making a selection. However, by directly touching the display screen, the touch screen thereupon is easily scratched or damaged.

Therefore, there is a need for an improved display apparatus and touch-based method therefore that can overcome the above-mentioned problems.

### SUMMARY

In one aspect of the present invention, a touch-based display apparatus is provided. The display apparatus is capable of displaying a roundish-shaped menu. The display apparatus includes a screen and a frame. The screen has a first menu region and a second menu region. Each menu region displays a menu therein. The menu in the second menu region is a sub-menu of a menu option of the menu in the first menu region. Furthermore, the menus are arranged in a roundish-shaped form. The frame is connected to the screen and has a first touch strip and a second touch strip thereof. Each touch strip corresponds to one of the menu regions, and allows one to select a desired menu option to perform an associated function.

In another aspect of the present invention, a touch-based method enabling a display apparatus to display a roundish-shaped menu is also provided, wherein the display apparatus has a screen and a frame connected to the screen, the screen having a first menu region and a second menu region, and the frame having a first touch strip corresponding to the first menu region and a second touch strip corresponding to the second menu region. The method includes the steps of: (a) receiving and processing any sensing signal from one of the touch strips; (b) displaying a roundish-shaped menu in the menu regions; (c) rotating menu options displayed in the first menu region in a direction corresponding to a stroke operation on the first touch strip in response to a plurality of sensing signals from the first touch strip; (d) rotating menu options displayed in the second menu region in a direction corresponding to a stroke operation on the second touch strip in response to a plurality of sensing signals from the second touch strip; and (e) performing a function associated with a selected menu option in response to a sensing signal from the second touch strip.

Other advantages and novel features will be drawn from the following detailed description with reference to the attached drawings, in which:

### BRIEF DESCRIPTION OF THE DRAWINGS

FIG. 1 is an exemplary schematic diagram of a touch-based display apparatus enabling to display a roundish-shaped menu in accordance with a preferred embodiment of the present invention, the display apparatus including a screen and a frame, the frame having a first touch strip and a second touch strip thereof;

FIG. 2 is a block diagram representing a hardware infrastructure of a sensing signal processing circuit for a touch sensitive unit beneath the touch strips of FIG. 1 with the signal processing circuit connecting to a processing unit;

FIG. 3 (including FIGS. 3A-3C) illustrates a menu structure having multiple menus displayed in a first menu region and a second menu region of the screen of FIG. 1 in accordance with a preferred embodiment of the present invention, each menu region corresponding to a touch strip of FIG. 1; and

FIG. 4 is a flowchart of a preferred touch-based method for enabling a display apparatus of FIG. 1 to display a roundish-shaped menu in accordance with a preferred embodiment of the present invention.

### DETAILED DESCRIPTION OF THE EMBODIMENTS

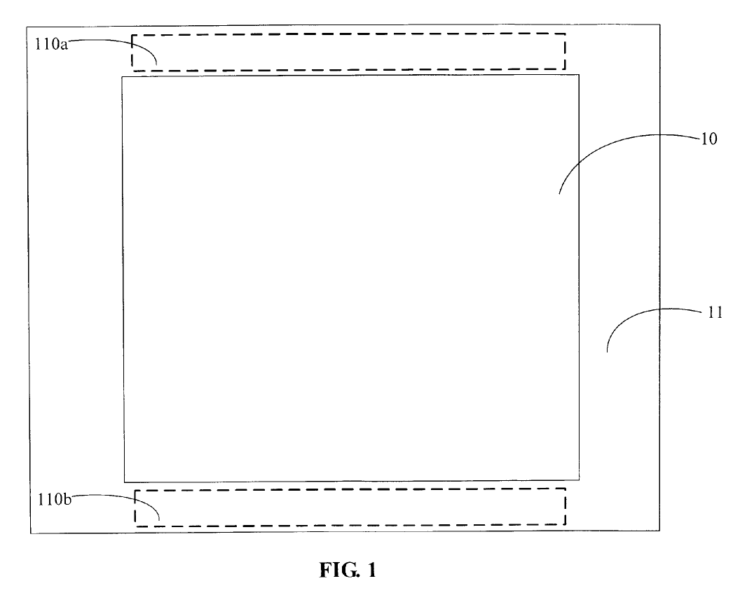

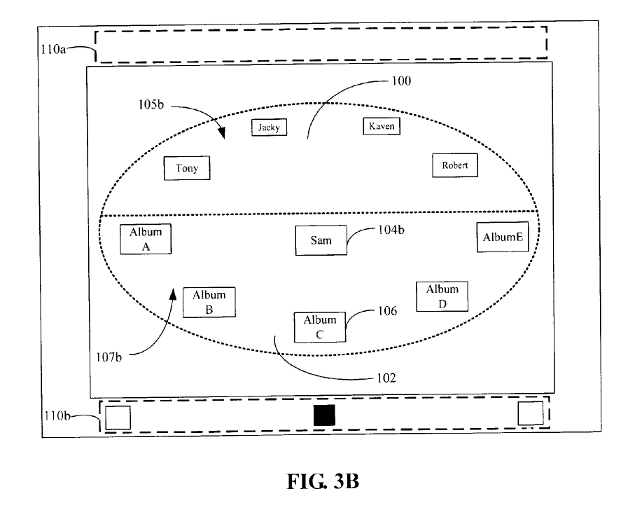

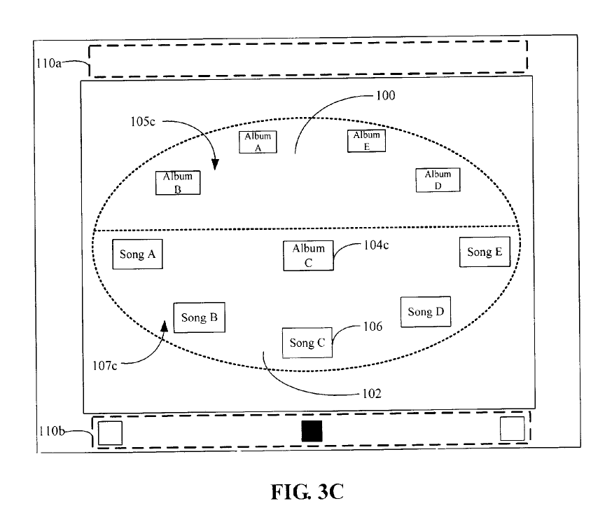

Referring to FIG. 1 and FIG. 3, a touch-based display apparatus 101 in accordance with a preferred embodiment of the present invention is shown. The display apparatus 101 includes a screen 10 and a frame 11. The screen 10 has a first menu region 100 and a second menu region 102. A first menu 105 can be displayed in the first menu region 100 therein, and a second menu 107 can be displayed in the second menu region 102 therein. The first menu 105 and the second menu 107 can be a part of a menu 103, i.e., each being a sub-menu of the menu 103. Alternatively, each can be an independent menu. Each of the first menu 105 and the second menu 107 has one or more menu options, at least some of which are displayed on the screen 10. One or more of the menu options for each of the first menu 105 and the second menu 107 may be hidden due to the limited space of the screen 10, but they are displayable one the screen 10.

Each menu option, as displayed, may be in a form of an icon. For example, the second menu 107 has a plurality of menu options or icons 106, 108, 112, 114, and 116. Each icon may have a corresponding graphical label. For instance, icon 106 has a corresponding graphical label 106a. The corresponding graphical label can be a word, a symbol, a sign, a figure, a photo, a number, an indicator, or any combination of them. For example, in the embodiment as shown in FIG. 3A, the icon 106 has a corresponding graphical label 106a “Sam”.

Each icon can be in a form of a geometrical shape such as a square, a rectangle, a triangle, a circle, an ellipse, or any desired geometrical shape at a designer's choice. For example, in the embodiment as shown in FIG. 3A, the icon 106 is in the form of a rectangle. The icons can be same, shape-wise or size-wise, or different. For example, in the embodiment as shown in FIG. 3A, the menu options or icons of the first menu 105 have different sizes, and the menu options or icons of the second menu 107 have substantially same size.

Furthermore, the menu options or icons of the first menu 105 and the second menu 107 are arranged on the screen 10 to be within and substantially along a curved contour line 111. The curved contour line 111 can be in a form of an open configuration or a closed configuration. For example, the curved contour line 11 can take a form of an ellipse, a circle, or a roundish-shaped form having at least a part of it being a part of a circle or an ellipse. For the benefit of readers of this disclosure and by way of example, in the embodiment as shown in FIG. 3A and FIG. 3B, the curved contour line 111 has a form of an ellipse, which is divided by a broken line 113 into the first menu region 100 and the second menu region 102. The broken line 113 can be positioned to pass through the center of the ellipse so that the first menu region 100 and the second menu region 102 are substantially equal to each other size-wise. The broken line 113 can also be positioned not to pass through the center of the ellipse so that one of the first menu region 100 and the second menu region 102 is larger than the other size-wise as shown in FIG. 3A, where the second menu region 102 is larger than the first menu region 100. The curved contour line 111 and the broken line 113 can be visible or invisible to a viewer.

In one embodiment as shown in FIG. 3A, the first menu region 100 displays a top part of the elliptical-type menu 103 as the first menu 105, whereas the second menu region 102 displays a bottom part of the elliptical-type menu 103 as the second menu 107. Moreover, a menu item or icon 104 is displayed in a position within the curved contour line 111 and in the second menu region 102. In this embodiment, as discussed in additional details below, the icon 104 establishes a relationship between the first menu 105 and the second menu 107 in which the second menu 107 constitutes a sub-menu of a menu option, namely the icon 104, in the first menu region 100. However, the designated relationship between the elliptical-type menu and the menu regions should not be construed as limiting the invention.

In addition, the size of a menu option or icon in the first menu region 100 depends on where the menu option or icon is displayed on the screen 10. In the embodiment as shown in FIG. 3A, a menu option or icon that is positioned closer to the broken line 113 is displayed in a size larger than that of a menu option or icon that is positioned away from the broken line 113. For example, the menu option or icon with a graphical label “Hip-Top” is displayed in a size larger than that of the menu option or icon with a graphical label “Folk”.

Furthermore, corresponding to the first menu region 100 and the second menu region 102, the frame 11 provides a first touch strip 110a and a second touch strip 110b thereon for being selectable by contact to perform a selected function associated with the menu options displayed in the first menu region 100 and the second menu region 102, respectively.

In one embodiment of the present invention, a contact on any one of the first touch strip 110a and the second touch strip 110b initiates the elliptical-type menu 103 to be displayed in the first menu region 100 and the second menu region 102. After initiating the elliptical-type menu 103, a further contact on the first touch strip 110a selects a desired menu option or icon of the menu options or icons displayed in the first menu region 100. That is, a stroke on the first touch strip 110a hides the currently displayed but now unselected menu options out of the first menu region 100 until the selected or desired menu option rotates or moves into the second menu region 102, thereby displaying a plurality of menu options of the sub-menu of the selected or desired menu option in the second menu region 102. Alternatively, a further contact on the second touch strip 110b selects a desired menu option of the menu displayed in the second menu region 102. That is, a stroke on the second touch strip 110b hides the currently displayed but now undesired menu options out of the second menu region 102 until the hidden but desired menu options appears in a selection area where the menu option 106 with the graphical label “Sam” is positioned of the second menu region 102. When the desired menu option appears in the selection area, a further touch on a corresponding location (e.g., the middle part symbolically indicated by a black block 156) of the second touch strip 110b activates or performs the function associated with the menu option such as, for example, expanding a sub-menu of the menu option, executing a selected operation indicated by the menu option, etc. Alternatively, a further touch on a designated selection part (e.g., the leftmost part symbolically indicated by a white block 158 or the rightmost part symbolically indicated by a white block 160) of the second touch strip 110b activates or performs a function of returning to a former elliptical-type menu.

In order to provide a friendly and easy user interface for the user, each touch strip is designed to correspond to one of the menu regions, that is, the first touch strip 110a corresponds to the first menu region 100 and the second touch strip 110b corresponds to the second menu region 102. Preferably, a length of each touch strip is designed to correspond to a length of the corresponding menu region. Furthermore, each touch strip has a plurality of touch sensitive units (not shown) beneath thereof for generating sensing signals to activate or perform the functions associated with the menu options displayed in the menu regions, in response to a contact on a corresponding location of the touch strip. Moreover, each touch sensitive unit includes a sensing signal processing circuit 112 (described in more detail below) for generating the sensing signals. Each touch sensitive unit is further assigned a coordinate for identification.

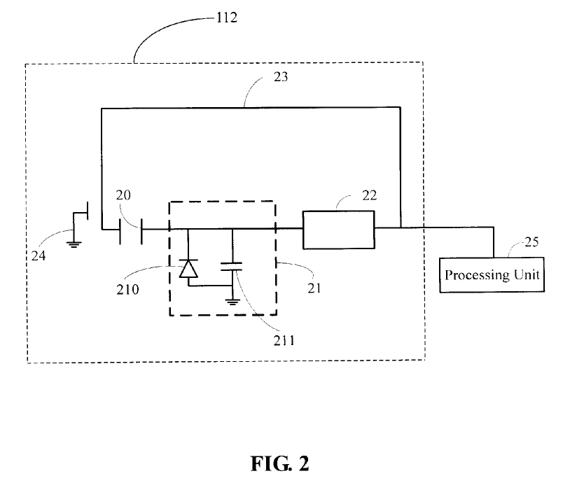

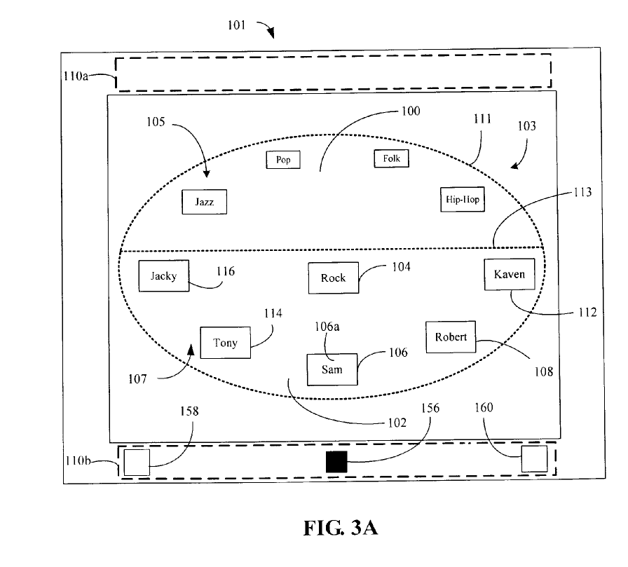

The display apparatus 101 further includes a processing unit 25, as shown in FIG. 2. Among other things, the processing unit 25 receives and processes the sensing signals from the touch sensitive units beneath the touch strips according to assigned coordinates therewith, and performs corresponding functions. For example, in response to a single sensing signal from one of the touch strips (i.e., the first touch strip 110a or the second touch strip 110b), the processing unit 25 processes the sensing signal, and initiates to display the elliptical-type menu 103 last displayed thereon in the menu regions. That is, the processing unit 25 respectively displays the menu and its associated sub-menu in the first menu region 100 and the second menu region 102.

In response to a plurality of sensing signals from the first touch strip 110a while the elliptical-type menu 103 is in display, the processing unit 25 rotates or moves the menu options displayed in the first menu region 100 in a direction mapped to a stroke operation on the first touch strip 110a according to the coordinates associated with the sensing signals. Furthermore, the processing unit 25 hides at least one of the menu options displayed in the first menu region 100 and replaces the at least one of the displayed menu options by one of the hidden menu options, and further displays a plurality of menu options of the sub-menu of the menu option that rotates into the second menu region 102. Moreover, the processing unit 25 displays a symbol, such as icon 104, mapped to the displayed menu option in a particular location of the screen 10.

In response to a plurality of sensing signals from the second touch strip 110b while the elliptical-type menu 103 is in display, the processing unit 25 rotates or moves the menu options displayed in the second menu region 102 in a direction mapped to a stroke operation on the second touch strip 110b according to the coordinates associated with the sensing signals. Furthermore, the processing unit 25 hides at least one of the menu options displayed in the second menu region 102 and replaces the at least one of the displayed menu options by one of the hidden menu options.

In response to a sensing signal from the second touch strip 110b, which is generated by pressing or touching, for example, the middle part thereof corresponding to the black block 156 while the elliptical-type menu 103 is in display, the processing unit 25 performs the function indicated by the selected menu option in the selection area of the second menu region 102. In addition, when the menu option has a sub-menu, the processing unit 25 causes to display a plurality of menu options of the sub-menu of the menu option in the selection area, namely, icon 106b with a graphical label “Album C”, icon 108b with a graphical label “Album D”, icon 112b with a graphical label “Album E”, icon 114b with a graphical label “Album B”, and icon 116b with a graphical label “Album A”, in the second menu region 102, which are corresponding to the displayed menu option or icon 106 with a graphical label “Sam” in the selection area of the screen 10.

Alternatively, in response to a sensing signal from the second touch strip 110b, which is generated by pressing or touching, for examples, the leftmost part corresponding to the white block 158 or the rightmost part corresponding to the white block 160 while the elliptical-type menu 103 is in display, the processing unit 25 performs the function of returning to a former elliptical-type menu.

FIG. 2 shows a block diagram of a sensing signal processing circuit 112 for the touch sensitive unit beneath the touch strips of FIG. 1 according to one embodiment of the present invention, wherein the sensing signal processing circuit 112 is in communication with the processing unit 25. The sensing signal processing circuit 112 has an antenna 20, a clamping circuit 21, a detector 22, a feedback line 23, and a grounding line 24. The antenna 20 is electrically coupled to the clamping circuit 21, which itself is electrically coupled to an input end of the detector 22. An output end of the detector 22 is respectively electrically coupled to the processing unit 25 and one end of the feedback line 23. The feedback line 23 forms a positive feedback circuit with the antenna 21. The grounding line 24, which takes the form of a space between two adjacent touch sensitive units, is for spacing the touch sensitive units therebetween.

It is known that the human body is electrically charged with noise and static signals. Therefore, when a user contacts or touches at least one of the first and second touch strips, at least some of the noise and static signals of the user with a desired signal may be received by the antenna 20. The antenna 20 transmits the received noise and static signals to the clamping circuit 21. However, the static electrical signals may cause interference to normal operation of the detector 22, and may even fry the detector 22. In addition, a strong noise may adversely influence a resulting sensing signal for the processing unit 25; that is, the sensitivity of the touch sensitive unit may be diminished, and the quality of the resulting sensing signal may be negatively impacted. Accordingly, the clamping circuit 21 is adapted for eliminating the static signals and for reducing the noise, thus improving the sensitivity accuracy of the touch sensitive unit.

The clamping circuit 21 in one embodiment of the present invention includes a diode 210, and a capacitor 211. The cathode of the diode 210 is electrically coupled to the antenna 20, while the anode is electrically coupled to ground. Upon receiving the noise and static signals with a desired signal, the diode 210 filters out the static signals to ground so as to avoid frying the detector 22, and reducing the noise influencing to the capacitor 211. The capacitor 211 further leaks a portion of the reduced noise to ground. Thus the reduced noise is further weakened, thereby obtaining a more accurate sensitivity.

The detector 22 has a high input impedance, so as to easily detect the desired signal with the reduced and weakened noise received from the input end of the detector 22. The detector 22 then converts the desired signal with the reduced and weakened noise into digital signals, namely the sensing signals, and transmits the sensing signals through the output end of the detector 22 to the processing unit 25 to perform corresponding controls. Furthermore, because the feedback line 23 forms a positive feedback circuit with the antenna 20, the noise generated as the user touches the edge of the touch sensitive unit is filtered, thereby further improving the sensitivity accuracy of the touch sensitive unit.

FIGS. 3A-3C illustrate a series of elliptical-type menus having different menu options that can be displayed in menu regions of the screen of the touch-based apparatus 101 as shown in FIG. 1 in accordance with a preferred embodiment of the present invention. As described above, the first menu region 100 and the second menu region 102 can respectively display a menu and an associated sub-menu therein, thereby forming an elliptical-type menu 103 in the screen 10. In this exemplary embodiment, contents of the menu options provide desired information related to music, and only three elliptical-type menus are illustrated therein. However, either the content of the menu options or the number of the elliptical-type menus are not to be construed as being limited thereto.

Therefore, each menu region is capable of displaying different parts of the information in different display states. For example, referring to FIG. 3A, where namely a first display state of the screen 10 is shown, the first menu region 100 displays a first menu 105 providing information related to music styles with menu options or icons having corresponding graphical labels “Pop”, “Jazz”, “Rock”, “Hip-Hop”, “Folk”, . . . , respectively, and the second menu region 102 displays a second menu 107 or a sub-menu of a desired music style menu option of the first menu 15 such as, for example, menu option or icon 104 with graphical label “Rock”, the sub-menu providing information related to rock music singers with menu options or icons having corresponding graphical labels “Jacky”, “Tony”, “Sam”, “Robert”, “Kaven”, . . . , respectively.

Referring to FIG. 3B, where namely a second display state of the screen 10 is shown, the first menu region 100 displays a first menu 105b providing information related to rock music singers, which contents have been displayed as the second menu 107 or the sub-menu in the first display state, and the second menu region 102 displays a second menu 107b or a sub-menu of a desired music singer menu option of the first menu 105b such as, for example, menu option or icon 104b with graphical labeling “Sam”, the sub-menu 107b providing information related to one rock music singer Sam's music albums with menu options or icons having corresponding graphical labels “Album A”, “Album B”, “Album C”, “Album D”, “Album E”, . . . , respectively.

Referring to FIG. 3C, where namely a third display state of the screen 10 is shown, the first menu region 100 displays a first menu 105c providing information related to music albums of one rock music singer Sam, which contents have been displayed as the second menu 107b or the sub-menu in the second display state, and the second menu region 102 displays a second menu 107c or a sub-menu of a desired music album menu option of the first menu 105c such as, for example, menu option or icon 104c with graphical labeling “Album C”, the sub-menu 107c providing information related to specific music names in “Album C” with menu options or icons having corresponding graphical labels “Song A”, “Song B”, “Song C”, “Song D”, “Song E”, . . . , respectively.

In addition, in each display state, the second menu region 102 displays a symbol mapped to the displayed menu option (i.e., icon 104 “Rock”, icon 104b “Sam”, or icon 104c “Album C”, respectively) in a particular location of the screen 10. Furthermore, the second menu region 102 may display the symbol in a selected mode for example, such as a flashing mode.

Accordingly, because the touch strips are used instead of function buttons for performing functions, the frame 11 can retain its neatness, regardless of how many functions the display apparatus 101 has. Furthermore, since the surface areas of the touch sensitive strips can be designed in smaller sizes, the frame 11 of the display apparatus 101 thereupon can be designed in a smaller size by using a narrow configuration, whereas the screen 10 thereof can be designed in a larger size, thereby the display apparatus 101 may not only obtain a neater appearance but may also posses a larger screen for display more information. Moreover, due to the utilization of the two-dimensional touch strips and dynamic roundish-shaped menus of the display apparatus 101, a user can easily select a desired menu option to perform the function associated therewith.

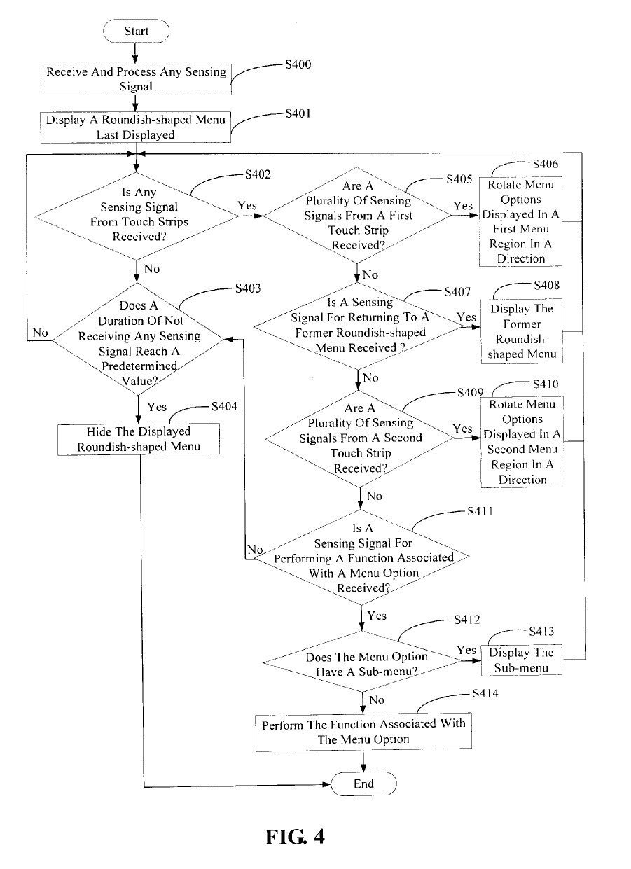

FIG. 4 is a flowchart of a method for enabling the display apparatus of FIG. 1 to display the roundish-shaped menu in accordance with a preferred embodiment of the present invention. In step S400, the processing unit 25 receives and recognizes any sensing signal from the touch sensitive units beneath the touch strips. In step S401, the processing unit 25 acts to display the roundish-shaped menu last displayed thereon in the menu regions. That is, the processing unit 25 respectively displays the menu and its associated sub-menu in the first menu region 100 and the second menu region 102.

In step S402, the processing unit 25 determines whether it receives any sensing signal mapped to the menu options of the displayed roundish-shaped menu.

If the processing unit 25 does not receive a sensing signal mapped to the menu options of the displayed roundish-shaped menu, in step S403, the processing unit 25 determines whether a duration of not receiving any sensing signal from the touch strips reaches a predetermined value. If the duration reaches the predetermined value, in step S404, the processing unit 25 acts to hide the roundish-shaped menu displayed on the menu regions, and the procedure is finished. If the duration does not reach the predetermined value, the procedure returns to step S402.

If the processing unit 25 does receive a sensing signal mapped to the menu options of the displayed roundish-shaped menu, in step S405, the processing unit 25 determines whether it further receives a plurality of sensing signals from the first touch strip 110a. If received, in step S406, the processing unit 25 determines a direction of the stroke operation on the first touch strip 110a according to the coordinates associated with the sensing signals, and rotates the menu options displayed in the first menu region 100 in the determined direction. Furthermore, the processing unit 25 acts to hide at least one of the menu options displayed in the first menu region 100 and replace at least one of the displayed menu options by another hidden menu option, and further display a plurality of menu options of the sub-menu of the menu option that rotates into the second menu region 102 and simultaneously displays the symbol mapped to the displayed menu option in the particular location 104 of the screen 10 in a flashing mode, and the procedure returns to step S402.

If not, in step S407, the processing unit 25 determines whether it receives the sensing signal for performing the function of returning to a former roundish-shaped menu, that is, the processing unit 25 determines whether the sensing signal is from the designated selection part (e.g., the leftmost part or the rightmost part) of the second touch strip 110b. If received, in step S408, the processing unit 25 displays the former roundish-shaped menu in the menu regions.

If not, in step S409, the processing unit 25 determines whether it receives a plurality of sensing signals from the second touch strip 110b. If received, in step S410, the processing unit 25 determines a direction of a stroke operation on the second touch strip 110b according to the coordinates associated with the sensing signals, and rotates the menu options displayed in the second menu region 102 in the determined direction. Furthermore, the processing unit 25 acts to hide at least one of the menu options displayed in the second menu region 102 and replace at least one of the displayed menu options by another hidden menu option, and the procedure returns to step S402.

If not, in step S411, the processing unit 25 determines whether it receives the sensing signal for performing the function associated with the menu option displayed in the selection area 106 from the second touch strip 110b, that is, the processing unit 25 determines whether the sensing signal is from the middle part of the second touch strip 110b. If not, the procedure returns to step S403.

If received, in step S412, the processing unit 25 determines whether the selected menu option has a sub-menu. If the selected menu option has a sub-menu, in step S413, the processing unit 25 displays a plurality of menu options of the sub-menu of the selected menu option in the second menu region 102 and displays the menu except the selected menu option in the first menu region 100, and further displays the symbol of the selected menu option in the particular location 104 of the screen 10 in a flashing mode, and the procedure returns to step S402.

If the selected menu option does not have a sub-menu, in step S414, the processing unit 25 performs the function associated with the selected menu option, and the procedure is finished.

Accordingly, in one aspect, the present invention relates to a method for enabling a display apparatus to display a menu structure having multiple menus, {Mi}, i=1, 2, . . . , N, N being an integer greater than zero, wherein the display apparatus has a screen having a first menu region and a second menu region. In one embodiment, the method comprises the steps of (a). displaying the ith menu, Mi, in the menu regions, wherein the ith menu, Mi, has a first menu and a second menu, wherein the first menu has a plurality of menu options and the second menu is a sub-menu of one of the plurality of menu options of the first menu and has a plurality of menu options, and wherein the plurality of menu options of the second menu are displayed in the second menu region and the plurality of menu options of the first menu are substantially displayed in the first menu region so that the plurality of menu options of the first menu and the plurality of menu options of the second menu, when displayed, are displayed on the screen substantially along a curved contour line; (b). activating a menu option of the plurality of menu options of the second menu of the ith menu, Mi; and (c). displaying the i+1th menu, Mi+1, in the menu regions, wherein the i+1th menu, Mi+1, has a first menu and a second menu, wherein the first menu of Mi+1 has a plurality of menu options and the second menu of Mi+1 is a sub-menu of one of the plurality of menu options of the first menu of Mi+1 and has a plurality of menu options, wherein the plurality of menu options of the second menu of the i+1th menu, Mi+1, are displayed in the second menu region to replace the plurality of menu options of the second menu of the ith menu, Mi, and the plurality of menu options of the first menu of the i+1th menu, Mi+1, are substantially displayed in the first menu region to replace the plurality of menu options of the first menu of the ith menu, Mi, so that the plurality of menu options of the first menu of Mi+1 and the plurality of menu options of the second menu of Mi+1, when displayed, are displayed on the screen substantially along a curved contour line, and wherein the first menu of the i+1th menu, Mi+1, is the second menu of the ith menu, Mi.

In the step of displaying the ith menu, Mi, in the menu regions, at least one of the plurality of menu options of the first menu of the ith menu, Mi, is displayed inside and away from the curved contour line.

For the embodiment where the curved contour line forms an ellipse, the at least one of the plurality of menu options of the first menu of the ith menu, Mi, is displayed inside and substantially near the center of the ellipse. The second menu of the ith menu, Mi, is corresponding to the at least one of the plurality of menu options of the first menu of the ith menu, Mi, which is displayed inside and substantially near the center of the ellipse.

In the exemplary embodiment shown in FIGS. 3A, 3B and 3C, respectively, menu 103 is the 1st menu (i=1), M1, that has a first menu 105 and a second menu 107. The second menu 107 of M1 is a sub-menu of menu option or icon 104 that is one of the plurality of menu options of the first menu 105 of M1. The 2nd menu (i+1=2), M2, has a first menu 105b and a second menu 107b. The second menu 107b of M2 is a sub-menu of menu option or icon 104b that is one of the plurality of menu options of the first menu 105b of M2. As displayed, the plurality of menu options of the second menu 107b of M2, are displayed in the second menu region 102 to replace the plurality of menu options of the second menu 107 of M1, and the plurality of menu options of the first menu 105b of M2, are substantially displayed in the first menu region 100 to replace the plurality of menu options of the first menu 105 of M1, where one of the menu options of the first menu 105b of M2, namely menu option or icon 104b, is displayed inside and substantially near the center of the ellipse to replace the menu option or icon 104 of the first menu 105 of M1. And the first menu 105b of M2 is the second menu 107 of M1. Furthermore, the 3rd menu, M3, has a first menu 105c and a second menu 107c. The second menu 107c of M3 is a sub-menu of menu option or icon 104c that is one of the plurality of menu options of the first menu 105c of M3.

In another aspect, the present invention relates to software stored on a computer readable medium for enabling a display apparatus to display a menu structure having multiple menus, {Mi}, i=1, 2, . . . , N, N being an integer greater than zero, wherein the display apparatus has a screen having a first menu region and a second menu region, to perform functions comprising: (a). displaying the ith menu, Mi, in the menu regions, wherein the ith menu, Mi, has a first menu and a second menu, wherein the first menu has a plurality of menu options and the second menu is a sub-menu of one of the plurality of menu options of the first menu and has a plurality of menu options, and wherein the plurality of menu options of the second menu are displayed in the second menu region and the plurality of menu options of the first menu are substantially displayed in the first menu region so that the plurality of menu options of the first menu and the plurality of menu options of the second menu, when displayed, are displayed on the screen substantially along a curved contour line; (b). activating a menu option of the plurality of menu options of the second menu of the ith menu, Mi; and (c). displaying the i+1th menu, Mi+1, in the menu regions, wherein the i+1th menu, Mi+1, has a first menu and a second menu, wherein the first menu has a plurality of menu options and the second menu is a sub-menu of one of the plurality of menu options of the first menu and has a plurality of menu options, wherein the plurality of menu options of the second menu of the i+1th menu, Mi+1, are displayed in the second menu region to replace the plurality of menu options of the second menu of the ith menu, Mi, and the plurality of menu options of the first menu of the i+1th menu, Mi+1, are substantially displayed in the first menu region to replace the plurality of menu options of the first menu of the ith menu, Mi, so that the plurality of menu options of the first menu of Mi+1 and the plurality of menu options of the second menu of Mi+1, when displayed, are displayed on the screen substantially along a curved contour line, and wherein the first menu of the i+1th menu, Mi+1, is the second menu of the ith menu, Mi. The software can be stored on a computer readable medium and read by a controller or processing unit 25 to perform corresponding functions.

In yet another aspect, the present invention relates to a display apparatus. In one embodiment, the apparatus has a screen having a first menu region for displaying a first menu and a second menu region for displaying a second menu, wherein the first menu comprises a plurality of menu options, the second menu comprises a plurality of menu options, and wherein the plurality of menu options of the first menu and the plurality of menu options of the second menu, when displayed, are displayed on the screen substantially along a curved contour line; and a frame connected to the screen and having a first touch strip corresponding to the first menu region and a second touch strip corresponding to the second menu region, each touch strip being selective to perform a function associated with a menu option displayed in a corresponding menu region when the touch strip is touched at a particular position.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A display apparatus capable of displaying a roundish-shaped menu, comprising:
a screen having a first menu region and a second menu region each displaying a corresponding menu therein, wherein the menu in the second menu region is a sub-menu of a menu option of the menu in the first menu region, and the menus are in a roundish-shaped form; and
a frame connected to the screen and having a first touch strip corresponding to the first menu region and a second touch strip corresponding to the second menu region, each touch strip being selective to perform a function associated with a menu option displayed in a corresponding menu region.

2. The apparatus according to claim 1, wherein each touch strip comprises a plurality of touch sensitive units for generating sensing signals in response to contact, and each touch sensitive unit is assigned a coordinate for identification.

3. The apparatus according to claim 2, wherein each touch sensitive unit further comprises a sensing signal processing circuit for generating the sensing signals.

4. The apparatus according to claim 3, further comprising a processing unit for processing the sensing signals and performing corresponding functions associated with the menu options.

5. The apparatus according to claim 4, wherein the processing unit acts to display the menu and the sub-menu in the first menu region and the second menu region, in response to a touch operation on any of the touch strips.

6. The apparatus according to claim 5, wherein the processing unit determines a direction of a stroke operation on the first touch strip according to the coordinates associated with the sensing signals, and rotates the menu options displayed in the first menu in the determined direction.

7. The apparatus according to claim 6, wherein the processing unit acts to hide at least one of the menu options displayed in the first menu region and replace at least one of the displayed menu options by another hidden menu option and display a plurality of menu options of the sub-menu of the menu option which rotates into the second menu region, in response to the stroke operation on the first touch strip.

8. The apparatus according to claim 7, wherein the processing unit further displays a symbol mapped to the displayed menu option in a particular location of the screen.

9. The apparatus according to claim 5, wherein the processing unit determines a direction of a stroke operation on the second touch strip according to the coordinates associated with the sensing signals, and rotates the menu options displayed in the second menu region in the determined direction.

10. The apparatus according to claim 9, wherein the processing unit acts to hide at least one of the menu options displayed in the second menu region and replace at least one of the displayed menu options by another hidden menu option, in response to the stroke operation on the second touch strip.

11. The apparatus according to claim 10, wherein the processing unit acts to display a plurality of menu options of a sub-menu of a selected menu option displayed in a selection area of the second menu region, in response to a touch operation on the middle part of the second touch strip.

12. The apparatus according to claim 10, wherein the processing unit acts to perform a function of returning to a former roundish-shaped menu, in response to a touch operation on a designated selection part of the second touch strip.

13. The apparatus according to claim 12, wherein the designated selection part is selected from the group consisting of the leftmost part of the second touch strip and the rightmost part of the second touch strip.

14. A method for enabling a display apparatus to display a roundish-shaped menu, wherein the display apparatus has a screen and a frame connected to the screen, the screen having a first menu region and a second menu region, and the frame having a first touch strip corresponding to the first menu region and a second touch strip corresponding to the second menu region, comprising the steps of:
receiving and processing any sensing signal from one of the touch strips;
displaying a roundish-shaped menu in the menu regions;
rotating menu options displayed in the first menu region in a direction corresponding to a stroke operation on the first touch strip in response to a plurality of sensing signals from the first touch strip;
rotating menu options displayed in the second menu region in a direction corresponding to a stroke operation on the second touch strip in response to a plurality of sensing signals from the second touch strip; and
performing a function associated with a selected menu option in response to a sensing signal from the second touch strip.

15. The method according to claim 14, further comprising the step of: hiding the displayed roundish-shaped menu when a duration of not receiving any sensing signal from the touch strips reaches a predetermined value.

16. The method according to claim 14, further comprising the step of:
returning to a former roundish-shaped menu in response to a sensing signal from a designated selection part of the second touch strip.

17. The method according to claim 16, wherein the designated selection part is selected from the group consisting of the leftmost part of the second touch strip and the rightmost part of the second touch strip.

18. The method according to claim 14, wherein the step of rotating menu options displayed in the first menu region further comprises the steps of:
hiding at least one of menu options displayed in the first menu region and replacing at least one of the displayed menu options by another hidden menu option and displaying a plurality of menu options of a sub-menu of the menu option which rotates into the second menu region.

19. The method according to claim 18, wherein the step of displaying a plurality of menu options of a sub-menu of the menu option which rotates into the second menu region further comprises the step of:
displaying a symbol mapped to the displayed menu option in a particular location of the screen.

20. The method according to claim 14, wherein the step of rotating menu options displayed in the second menu region further comprises the step of:
hiding at least one of menu options displayed in the second menu region and replacing at least one of the displayed menu options by another hidden menu option.

21. The method according to claim 14, wherein the step of performing a function associated with a selected menu option when receiving a sensing signal from the second touch strip further comprises the step of:
displaying a sub-menu of the selected menu option if the selected menu option has the sub-menu.

22. The method according to claim 21, wherein the sensing signal is from the middle part of the second touch strip.

23. A display apparatus, comprising:
a screen having a first menu region for displaying a first menu and a second menu region for displaying a second menu, wherein the first menu comprises a plurality of menu options, the second menu comprises a plurality of menu options, and wherein the plurality of menu options of the first menu and the plurality of menu options of the second menu, when displayed, are displayed on the screen substantially along a curved contour line; and
a frame connected to the screen and having a first touch strip corresponding to the first menu region and a second touch strip corresponding to the second menu region, each touch strip being selective to perform a function associated with a menu option displayed in a corresponding menu region when the touch strip is touched at a particular position.

24. The apparatus according to claim 23, wherein at least one of the plurality of menu options of the first menu is displayed inside and away from the curved contour line.

25. The apparatus according to claim 24, wherein the curved contour line forms an ellipse, and the at least one of the plurality of menu options of the first menu is displayed inside and substantially near the center of the ellipse.

26. The apparatus according to claim 24, wherein the second menu is a sub-menu having menu options corresponding to the at least one of the plurality of menu options of the first menu.

27. A method for enabling a display apparatus to display a menu structure having multiple menus, {Mi}, i=1, 2, . . . , N, N being an integer greater than zero, wherein the display apparatus has a screen having a first menu region and a second menu region, comprising the steps of:
(a). displaying the ith menu, Mi, in the menu regions, wherein the ith menu, Mi, has a first menu and a second menu, wherein the first menu has a plurality of menu options and the second menu is a sub-menu of one of the plurality of menu options of the first menu and has a plurality of menu options, and wherein the plurality of menu options of the second menu are displayed in the second menu region and the plurality of menu options of the first menu are substantially displayed in the first menu region so that the plurality of menu options of the first menu and the plurality of menu options of the second menu, when displayed, are displayed on the screen substantially along a curved contour line;
(b). activating a menu option of the plurality of menu options of the second menu of the ith menu, Mi; and
(c). displaying the i+1th menu, Mi+1, in the menu regions,
wherein the i+1th menu, Mi+1, has a first menu and a second menu,
wherein the first menu has a plurality of menu options and the second menu is a sub-menu of one of the plurality of menu options of the first menu and has a plurality of menu options,
wherein the plurality of menu options of the second menu of the i+1th menu, Mi+1, are displayed in the second menu region to replace the plurality of menu options of the second menu of the ith menu, Mi, and the plurality of menu options of the first menu of the i+1th menu, Mi+1, are substantially displayed in the first menu region to replace the plurality of menu options of the first menu of the ith menu, Mi, so that the plurality of menu options of the first menu of Mi+1 and the plurality of menu options of the second menu of Mi+1, when displayed, are displayed on the screen substantially along a curved contour line, and
wherein the first menu of the i+1th menu, Mi+1, is the second menu of the ith menu, Mi.

28. The method according to claim 27, wherein in the step of displaying the ith menu, Mi, in the menu regions, at least one of the plurality of menu options of the first menu of the ith menu, Mi, is displayed inside and away from the curved contour line.

29. The method according to claim 28, wherein the curved contour line forms an ellipse, and the at least one of the plurality of menu options of the first menu of the ith menu, Mi, is displayed inside and substantially near the center of the ellipse.

30. The method according to claim 29, wherein the second menu of the ith menu, Mi, is corresponding to the at least one of the plurality of menu options of the first menu of the ith menu, Mi, which is displayed inside and substantially near the center of the ellipse.

31. Software stored on a computer readable medium for enabling a display apparatus to display a menu structure having multiple menus, {Mi}, i=1, 2, . . . , N, N being an integer greater than zero, wherein the display apparatus has a screen having a first menu region and a second menu region, to perform functions comprising:
(a). displaying the ith menu, Mi, in the menu regions, wherein the ith menu, Mi, has a first menu and a second menu, wherein the first menu has a plurality of menu options and the second menu is a sub-menu of one of the plurality of menu options of the first menu and has a plurality of menu options, and wherein the plurality of menu options of the second menu are displayed in the second menu region and the plurality of menu options of the first menu are substantially displayed in the first menu region so that the plurality of menu options of the first menu and the plurality of menu options of the second menu, when displayed, are displayed on the screen substantially along a curved contour line;
(b). activating a menu option of the plurality of menu options of the second menu of the ith menu, Mi; and
(c). displaying the i+1th menu, Mi+1, in the menu regions,
wherein the i+1th menu, Mi+1, has a first menu and a second menu,
wherein the first menu of Mi+1 has a plurality of menu options and the second menu of Mi+1 is a sub-menu of one of the plurality of menu options of the first menu of Mi+1 and has a plurality of menu options,
wherein the plurality of menu options of the second menu of the i+1th menu, Mi+1, are displayed in the second menu region to replace the plurality of menu options of the second menu of the ith menu, Mi, and the plurality of menu options of the first menu of the i+1th menu, Mi+1, are substantially displayed in the first menu region to replace the plurality of menu options of the first menu of the ith menu, Mi, so that the plurality of menu options of the first menu of Mi+1 and the plurality of menu options of the second menu of Mi+1, when displayed, are displayed on the screen substantially along a curved contour line, and
wherein the first menu of the i+1th menu, Mi+1, is the second menu of the ith menu, Mi.
